(19) United States
(12) Patent Application Publication
(10) Pub. No.: US 2018/0093526 A1
(43) Pub. Date: Apr. 5, 2018

(54) PALETTE WET KEEPER

(71) Applicant: CHI WANG KIM, LOS ANGELES, CA (US)

(72) Inventor: CHI WANG KIM, LOS ANGELES, CA (US)

(21) Appl. No.: 15/285,163

(22) Filed: Oct. 4, 2016

(51) Int. Cl. B44D 3/02; B65D 81/20; B65D 43/16; B65D 43/22

(52) U.S. Cl. CPC B44D 3/02; B65D 43/22; B65D 43/16; B65D 81/2038

(57) ABSTRACT

A palette wet keeper in which a palette on which oil color or acrylic color is squeezed to be used is put into a box, the box is vacuumized to block a contact of air, and thus prevents a hardening of the oil color or acrylic color.

### FIELD OF INVENTION

The present invention provides a method of capable of preserving oil color or acrylic color squeezed on a palette which is used in an art work such that the oil color or acrylic color is not dried and changed when the oil color or acrylic color is kept for a long time.

### BACKGROUND OF INVENTION

In the case of an art work, various colors of oil color or acrylic color is squeezed on a palette and the oil color or acrylic color is mixed using a brush or a knife to make and use oil color or acrylic color. However, since work is performed for several days, the oil color or acrylic color used on the palette is preserved in the state in which the oil color or acrylic color is squeezed on the palette. Therefore, when the oil color or acrylic color is used next time, oil color or acrylic color is hardened and thus the oil color or acrylic color cannot be used. Thus, it is a real in which whole oil color or acrylic color is thrown away and the oil color or acrylic color should be squeezed on the palette again to make the oil color or acrylic color.

In some cases, the oil color or acrylic color is covered by a thin vinyl wrap and is stored in a freezer of a refrigerator, or the oil color or acrylic color is packed in an enclosed box, in order to block an air maximally, but in theses cases, a hardened time is merely extended a little. Because an economic lost is invaluable according this, and in order to resolve inconveniences according this, a storage system which is for preventing a hardening of the watercolor even though the watercolor is stored for a long time, by blocking an air and keeping the storage system in a vacuum state, is developed.

### SUMMARY OF INVENTION

The palette on which the watercolor is squeezed and is used is put in a box, and the box is in a vacuum state to block a contact of air, and thus a hardening of the oil color or acrylic color is prevented. Although the oil color or acrylic color is stored for a long time, the oil color or acrylic color may be used again and thus an economic effect is expected. The made oil color or acrylic color may be used again, and thus a memory effect may be great.

### BRIEF DESCRIPTION OF THE DRAWINGS

FIG. 1 is an existing palette.

FIG. 2 is a top view of a vacuum pump separated type of the present invention.

FIG. 3 is a top view of a vacuum pump assembled type of the present invention.

FIG. 4 is a top view in which a cap is closed in a separated type box.

FIG. 5 is a top view in which a cap is closed in an assembled type box.

### DETAILED DESCRIPTION OF EMBODIMENTS

The present invention relates to a palette wet keeper which prevents a hardening of oil color or acrylic color, since a palette on which the oil color or acrylic color is squeezed to be used is put in a box, and the box is kept in a vacuum state to block a contact of air.

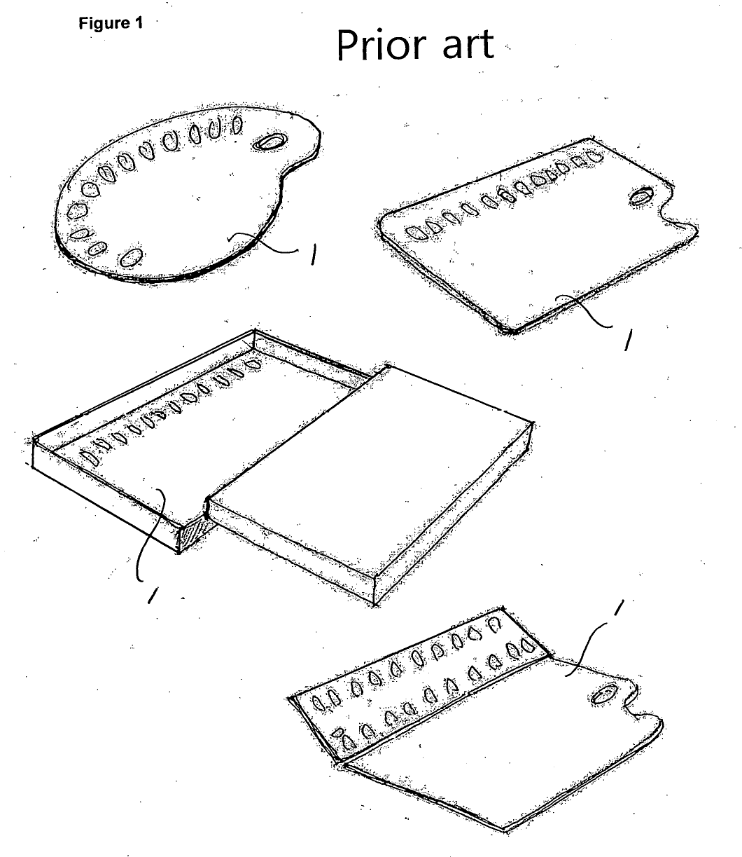

FIG. 1 is an existing used palette 1. In the case of an art work, various colors of oil color or acrylic color is squeezed on the palette 1 and is mixed using a brush or a knife to make a color and to use the oil color or acrylic color. Since, a work is performed for several days, the oil color or acrylic color used on the palette 1 is preserved in the state in which the oil color or acrylic color is squeezed on the palette. Therefore, when the oil color or acrylic color is used next time, the oil color or acrylic color is hardened and thus the oil color or acrylic color cannot be used. Thus, it is a real in which whole oil color or acrylic color is thrown away and the oil color or acrylic color should be squeezed on the palette again to make the oil color or acrylic color.

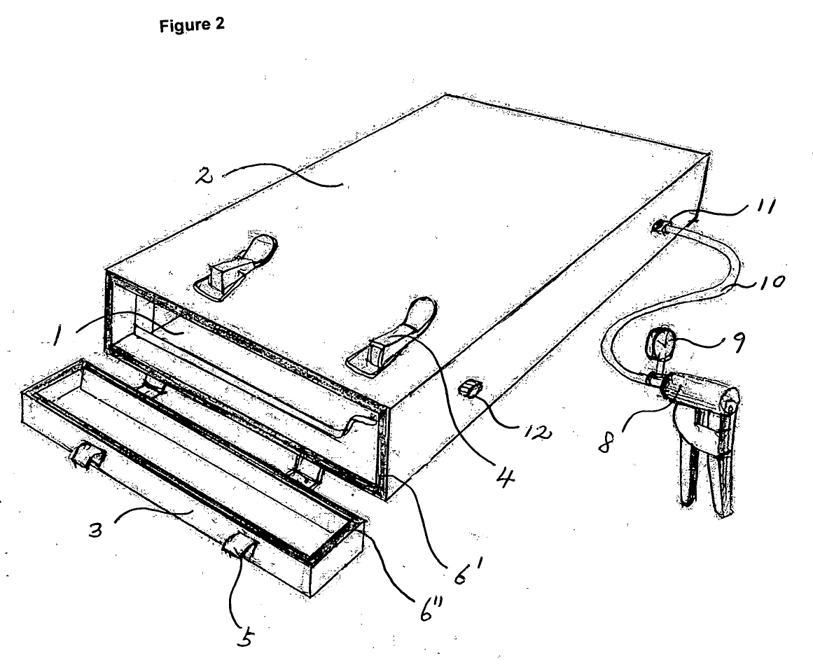

In FIG. 2, the palette 1 is inserted into a body 2 made of a plastic, a steel, a wood, an FRP, or PVC material, and a cap 3 made of a plastic, a steel, a wood, an FRP, or PVC material is closed. The draw latch 4 is locked to a draw latch rack 5, and a handle is bended back. Accordingly, a rubber seal 6 is tightly joined and fixed such that air is not flowed.

Next, an air check valve 11 is combined with a flexible air pipeline 10, and makes it a vacuum state using a vacuum pump 8. When the vacuum state is made, the process should be stopped while seeing a pressure of a compression gauge 9. Finally, the flexible air pipeline 10 is separated from the air check valve 11 and is stored. When the palette 1 is to be used again, when a handle of an air valve (out) 12 is turned, air is inserted into the body 2 again. Accordingly, the cap 3 may be opened, and the palette 1 is taken out to be used.

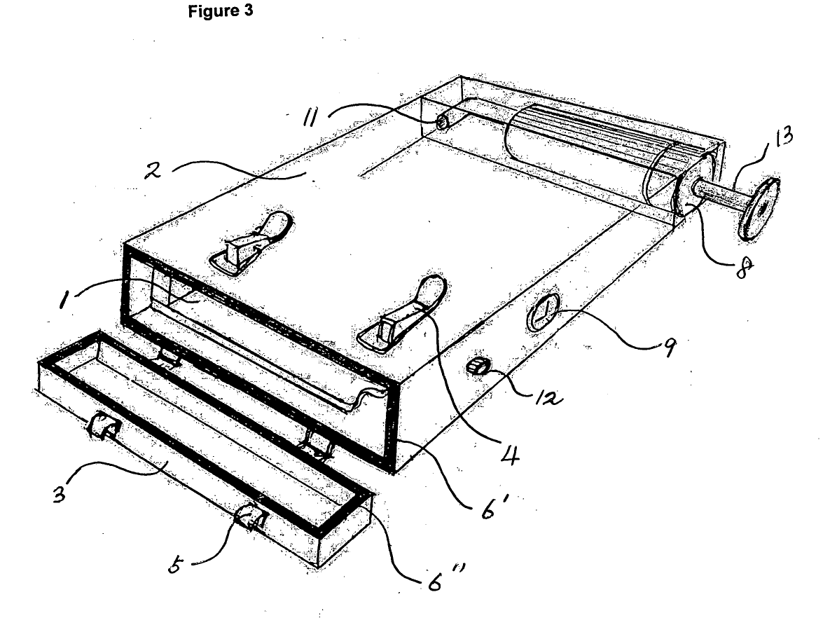

In FIG. 3, the palette 1 is inserted into the body 2 made of a plastic, a steel, a wood, an FRP, or PVC material, and the cap 3 made of a plastic, a steel, a wood, an FRP, or PVC material is closed. The draw latch 4 is locked to the draw latch rack 5, and the handle is bended back. Accordingly, the rubber seal 6 is tightly joined and fixed such that air is not flowed.

Next, a vacuum state is made through the air check valve 11 using an assembled vacuum pump 8 attached to the body 2. When the vacuum state is made, the process should be stopped while seeing the pressure of the compression gauge 9. In the case of the assembled type, a pump handle 13 of the vacuum pump 8 may be pushed to the inside of the body 2 to store the pump handle 13 easily, and thus there is no danger of loss of the vacuum pump 8.

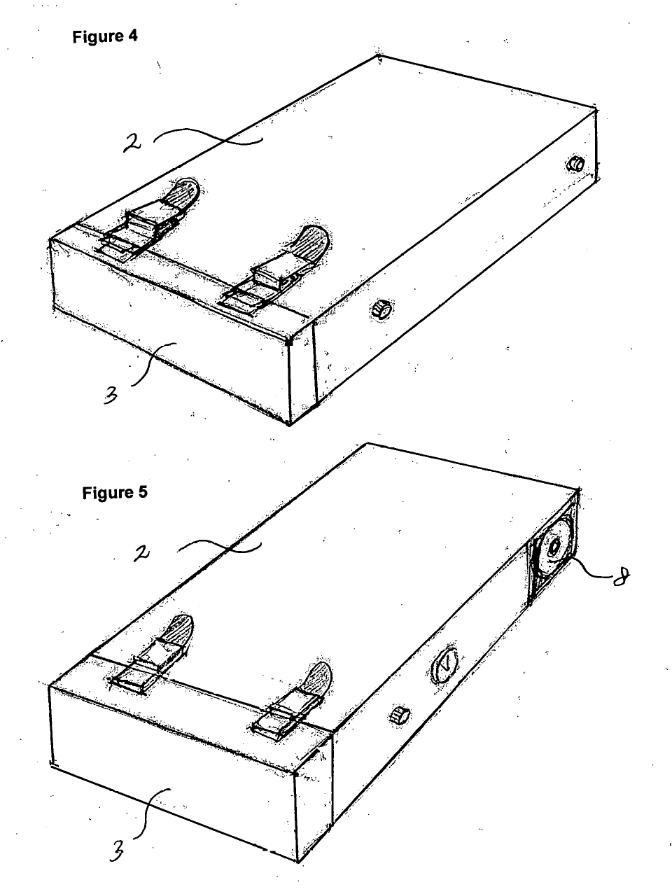

FIG. 4 is a top view of a separated type box 2 in which the vacuum pump 8 is separated and of which the cap 3 is closed. FIG. 5 is a top view of an assembled type box 2 in which the vacuum pump 8 is included and of which the cap 3 is closed.

1. A palette wet keeper, comprising of:
a body into which a palette is inserted;
a cap capable of being closed;
a draw latch disposed on the body;
a draw latch rack disposed on the cap, and capable of locking to the draw latch;
an assembled vacuum pump attached to the body;
an air check valve between the assembled vacuum pump and the body, and
a pump handle of the vacuum pump capable of being pushed to the inside of the body to store the pump handle easily.

2. (canceled)

3. (canceled)

4. (canceled)
